(19) United States
(12) Patent Application Publication
(10) Pub. No.: US 2015/0196971 A1
(43) Pub. Date: Jul. 16, 2015

(54) Method for the Regenerative Production of a Turbine Wheel with a Shroud

(71) Applicant: Robert Bosch GmbH, Stuttgart (DE)

(72) Inventors: Helmut Schneider, Aichtal (DE); Nikolaus Hautmann, Ditzingen (DE); Peter Rueck, Merkendorf (DE); Andreas Burghardt, Stuttgart (DE); Hannes Willeck, Stuttgart (DE); Antonius Gress, Ornbau (DE); Martin Schoepf, Stuttgart (DE)

(21) Appl. No.: 14/594,787

(22) Filed: Jan. 12, 2015

(30) Foreign Application Priority Data
Jan. 13, 2014 (DE) 10 2014 200 381.4

(51) Int. Cl. B23K 15/00; B23K 26/00; B23P 15/00; B23K 26/34

(52) U.S. Cl. CPC B23K 15/0086; B23K 26/345; B23K 26/0012; B23K 15/0006; B23P 15/006; B33Y 10/00

(57) ABSTRACT

A turbine wheel includes, a hub body, a plurality of turbine blades integrally formed with the hub body, and a shroud. The shroud encompasses the hub body, is integrally formed with the turbine blades, and interconnects the respective radial outer edges of the turbine blades. A method of producing the turbine wheel in one piece via primary forming includes applying a layer of powdered material having a predetermined layer thickness to a construction platform, selectively melting the layer of powdered material with reference to a current layer form of the turbine wheel, moving the construction platform by a predetermined amount, and repeating applying, selective melting, and moving until a last layer of the turbine wheel is formed.

This application claims priority under 35 U.S.C. § 119 to patent application no. DE 10 2014 200 381.4, filed on Jan. 13, 2014 in Germany, the disclosure of which is incorporated herein by reference in its entirety.

### BACKGROUND

In contrast to axial turbines and low-speed radial machines, high-speed turbine wheels, which are radially open, are used for applications in exhaust gas turbochargers of private motor vehicles or of commercial vehicles. As a result of the radially open construction, a leakage flow occurs from the pressure side to the suction side on the outer side of the turbine blades facing the stationary housing.

In principle, the efficiency of radial turbines of exhaust gas turbochargers is determined predominantly by the dimension of the radial gaps between the turbine wheel and the respective adjoining housing. In this case, the efficiency of the radial turbine is reduced with the increasing percentage proportion of the radial gap, wherein the causes for this are to be found in the overflow losses in the region of the blade tips and in pressure losses across the entire turbine housing. In addition to this, it can be observed that the smaller the design of the exhaust gas turbocharger is, the greater the pressure loss is with an associated reduction of the efficiency, since the smaller the turbine wheel is, the larger the relative width of the radial gap between the turbine wheel and the housing is.

The use of a so-called ‘shroud’ for closing the radial opening towards the housing, which can completely block the gap flow and therefore has a great potential for increasing the efficiency for an exhaust gas turbocharger, constitutes an effective measure for preventing the previously described, undesirable reduction of the efficiency.

Up to now, turbine wheels for exhaust gas turbochargers with or without a shroud have customarily been produced by means of precision casting, alternatively these can also be milled in the case of correspondingly machinable materials.

Thus, DE 20 2012 009 739 U1 discloses an integrally cast turbine wheel with a large number of rotor blades which on their free ends have a shroud which is provided especially for use within the scope of an exhaust gas turbocharger for charged internal combustion engines. The shroud is realized in this case during the casting of the turbine wheel.

Furthermore, an exhaust gas turbocharger with a radial turbine and a shroud, in which the shroud is formed as a deep-drawn part from a high heat-resistant steel plate, is known from DE 10 2009 031 787 A1, wherein the shroud is fastened to the turbine wheel blades by means of welding, especially laser welding, spot welding, friction welding, plasma welding or electric arc welding. Disclosed in addition to this is that the turbine wheel and the shroud can be formed as a one-piece cast part, especially as a pressure cast part or centrifugally cast part. A disadvantage in the case of a welding method for connecting the shroud to the blades of the turbine is the cost as a result of the joining process and also the weak points, associated therewith, in the joining region, for example as a result of notches. With regard to the casting of the radial turbine with the shroud, there are also limitations in the design of the turbine blades and generally of thin-walled structures.

### SUMMARY

The method disclosed herein for the generative production of a turbine wheel with a shroud has the advantage that now as a result of the generative production of the turbine wheel with a shroud both the joining process for connecting the shroud to the turbine blades which has been required up to now and the weak points in the joining region associated therewith, for example as a result of notches, can be dispensed with. In turn, a higher level of reliability and an extended service life of the turbine wheel or of the exhaust gas turbocharger result from this.

Furthermore, the previous restriction with regard to a realization of flow-optimized geometries for the turbine blades is advantageously lifted with the present production method in comparison to the production by means of the precision casting or milling for production methods customarily used up to now. Therefore, a higher degree of freedom is also possible both in the design of turbine blades and in the design of the connecting region of the turbine blades to the shroud or of the connecting region of the turbine blades to the hub body.

Furthermore, with the present method the vibration behavior of the turbine blades during operation of the turbine wheel can be advantageously improved by increasing the rigidity of the turbine wheel as a result of the selected construction of the turbine wheel with the shroud, as a result of which the smooth running of the turbine wheel is increased, which leads to less material fatigue in the shaft which supports the turbine wheel and to less operating noises. Furthermore, the rigidity of the turbine blades as a result of accommodating the radial ends of the turbine blades in the shroud advantageously permits smaller thicknesses for the turbine blades, which leads to an improvement of the dynamic behavior of the turbine wheel on account of the weight saving which is achieved.

The essence of the present disclosure is the realization of an advantageous production of metal turbine wheels with an integrated shroud by means of a generative manufacturing method or an additive manufacturing method which forms a large number of layers for producing the turbine wheel with the shroud. Therefore, the production of turbine wheels with a shroud in a single component is made possible and can therefore be realized without subsequent costly joining processes. The information for the layered production of the present turbine wheel with the shroud is derived from an associated CAD data set, especially from a three-dimensional model of the turbine wheel and is the basis for the present generative manufacturing method.

According to a further embodiment of the present method, the step of selective melting of the layer can be locally carried out by means of selective laser melting of by means of electron beam melting. On account of their suitability for the processing of metallic materials, the so-called selective laser melting (SLM) and the electron beam melting (EBM) are preferably the methods of choice for constructing metal turbine wheels with a shroud. In this case, when the step of selective melting of the layer is being carried out, the powdered material is locally melted in each case by the action of the selective laser melting or of the electron beam melting. Advantageously resulting from this is a very fine, homogenous structure in the turbine wheels with the shroud which are produced by means of the present method, which structure has virtually no pores or cavities, which leads to an advantage with regard to the (operating) strength compared with those turbine blades which are produced by means of precision casting.

In the case of the present method, a layer of the applied powdered material can have a thickness of between 50 μm and 500 μm. Furthermore, the layer of the applied powdered material can have a thickness of between 80 μm and 400 μm, in particular the layer of the applied powdered material can have a thickness of between 100 μm and 300 μm. Such thicknesses on the one hand ensure a production of the turbine wheel with the shroud which is as rapid as possible on account of required layers which are as few as possible, and on the other hand ensure a reliable melting of the powdered material during the production of the current layer of the turbine wheel.

According to a further embodiment of the present method, during the selective melting of the layer of powdered material according to the current layer form of the turbine wheel, the melted-on material can be fused with the preceding layer. Advantageously resulting from this is a very fine, homogenous structure in the turbine wheels with the shroud which are produced by means of the present method, which structure has virtually no pores or cavities, which leads to the previously described advantage compared with those turbine wheels which are produced by means of precision casting.

According to a further embodiment of the present method, a large number of turbine wheels can be produced at the same time on the construction platform with the aid of the method. This advantageously leads to an economical manufacture on account of the parallel construction of a plurality of turbine wheels with the shroud in one component plane so that a plurality of turbine wheels with the shroud can be produced at the same time on a single production line.

According to a further embodiment of the present method, the step of moving the construction platform by a predetermined amount can be realized as a lowering of the construction platform by the predetermined amount. In this case, the predetermined amount can be equal to the predetermined layer thickness.

According to a further embodiment of the present method, the powdered material can feature a nickel-based alloy, titanium aluminide and/or a metallic material. As a nickel-based material, Inconel®, for example, can be used. In principle, all metallic materials, which can be converted from the original powder form into a subsequently solid form by means of local melting, can be used in the case of the present method.

According to a further embodiment of the present method, the hub body can have a hollow structure, at least in certain sections. As result of this, the weight disadvantage on account of the additional shroud can advantageously be compensated with the aid of the hollow structure(s) in the hub body. A hollow structure serves in this case primarily for making a saving in material in a predetermined volume compared with a fully filled out volume, as a result of which a lightweight structure is realized.

According to a further embodiment of the present method, the hollow structure can be formed inside the hub body. In addition or alternatively to this, the hollow structure can also be formed in the region of the surface of the hub body, providing this is not required for the connection of the turbine blades.

According to a further embodiment of the present method, the hollow structure can have a lattice-like or honeycomb-like design. The hollow structure is basically to realize a strength of the hub body which is as high as possible with a weight which is as low as possible. In other words, the hollow structure is to lead to a strength of the hub body with a weight which as low as possible. All regular or irregular designs can be provided in principle for the hollow structures. In this case, the hollow structure can be designed for example in the form of a plurality of diagonally arranged, parallel planes.

### BRIEF DESCRIPTION OF THE DRAWINGS

The present disclosure is explained with reference to the attached drawings. In the drawings in this case

FIG. 1 shows a view of the method principle of the present disclosure,

FIG. 2 shows a perspective view of a turbine wheel with a shroud for an exhaust gas turbocharger of a PKW,

FIG. 3 shows a perspective view of a plurality of turbine wheels with shroud according to FIG. 2 in one component plane, and

FIG. 4 shows a sectional view from the side of a turbine wheel with a shroud, which has an internal hollow structure which was produced according to the present disclosure.

### DETAILED DESCRIPTION

Before the method for the generative production of a turbine wheel with a shroud according to the present disclosure is now described below, the basic configuration of a turbine wheel with a shroud shall first of all be explained.

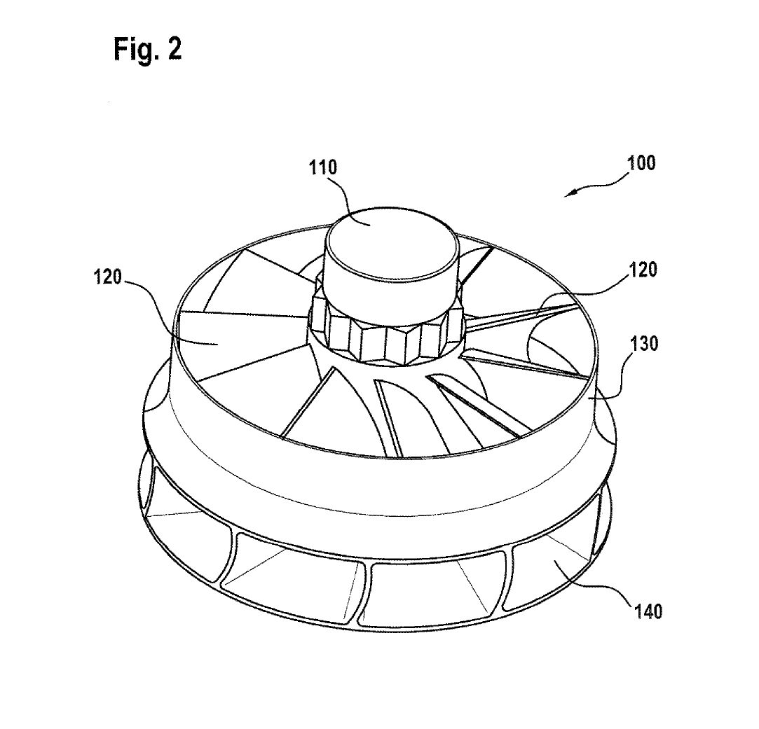

With reference to FIG. 2, a perspective view of a turbine wheel 100 with a shroud 130 for an exhaust gas turbocharger of a PKW (not shown) is illustrated, which turbine wheel comprises a hub body 110, a plurality of turbine blades 120 formed integrally with the hub body 110, and also the encompassing shroud 130 which interconnects the turbine blades 120 by their respective radially outer edges and which is formed integrally with said turbine blades 120. In other words, the shroud 130 encompasses the radial ends of the turbine blades 120, at least in certain sections, along their height.

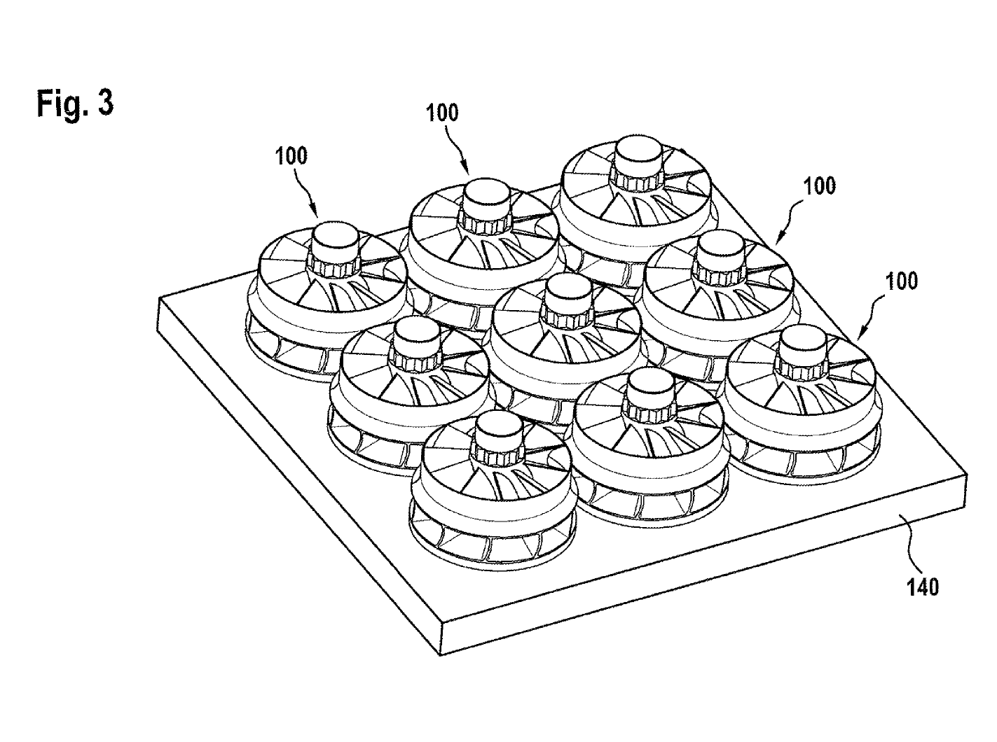

FIG. 3 shows a perspective view of a plurality of turbine wheels 120 with shroud according to FIG. 2 in one component plane which are formed on a construction platform 140. This advantageously leads to an economical manufacture on account of the parallel construction of a plurality of turbine wheels with the shroud in one component plane so that a plurality of turbine wheels with the shroud can be produced at the same time on a single production line for the present method.

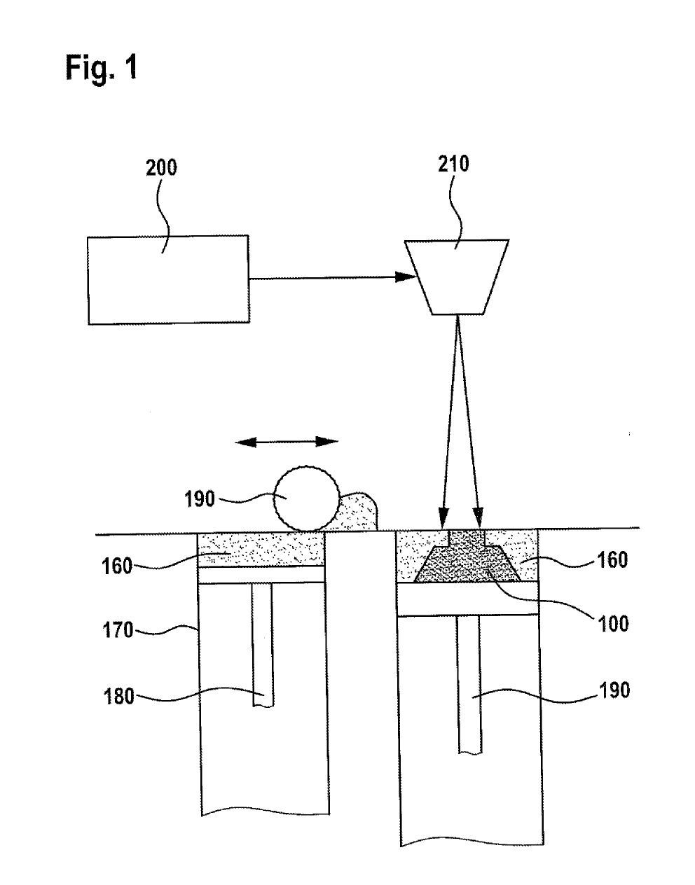

FIG. 1 shows a view of the method principle of the present disclosure. In this case, the present method for the generative production of a turbine wheel 100 (shown only schematically) with a shroud (not shown), wherein the turbine wheel, with the aid of the present method, is produced in one piece by primary forming, featuring the following steps.

First of all, provision is made for a powdered material 160 which is provided for layered forming of the turbine wheel 100. The powdered material 160 is stored in a container 170, wherein a lifting device 180, which lifts the powdered material 160 by a predetermined amount after a complete manufacturing step has been conducted, is provided in the container 170. The powdered material 160 can be a nickel-based alloy, titanium aluminide and/or a metallic material. As a nickel-based alloy, Inconel®, for example, can be used. In principle, all metallic materials, which can be converted from the original powder form into a subsequently solid form by means of local melting, can be used in the case of the present method.

After this, a layer of powdered material 160, with the aid of a doctor blade 190, is applied with a predetermined layer thickness to a construction platform (not shown). After completion of the application of powdered material 160, the doctor blade 190 is moved back again into the region of the container 170 into the initial position (see arrow).

A selective melting of the layer of powdered material 160 is now carried out according to the current layer form of the turbine wheel 100. In this case, the step of selective melting of the layer is locally carried out by means of selective laser melting or by means of electron beam melting. As a result, while conducting the step of selective melting of the layer, the powdered material 160 is locally melted in each case by the action of the selective laser melting or of the electron beam melting. To this end, an energy beam (see arrow for this) from an energy source 200 is sent to a scanner 210 which in turn directs the energy beam in the direction towards the layer of powdered material 160 in order to locally melt this in a purposeful manner. After the energy beam has been guided away, the molten material rapidly solidifies.

After this, the construction platform is moved by a predetermined amount by means of a movement device 190, especially lowered by a layer thickness in this case.

Finally, the preceding steps are repeated on the respectively uppermost layer until the last layer of the turbine wheel 100 is formed. The turbine wheel 100 can then be withdrawn from the production line and the turbine wheel 100 is removed from the construction platform.

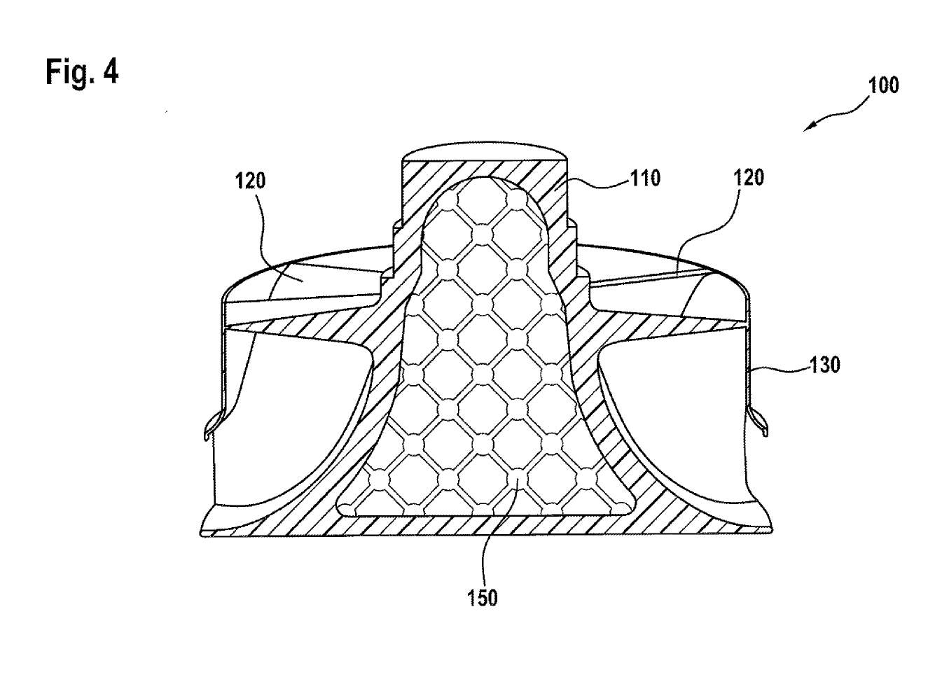

FIG. 4 shows a sectional view from the side of a turbine wheel 100 with a shroud 130 which has an internal hollow structure 150, wherein the turbine wheel 100 was produced according to the present disclosure. As a result of this, the weight disadvantage on account of the shroud 130 can be advantageously compensated with the aid of the hollow structure 150 in the hub body 110. The hollow structure is basically to realize a rigidity of the hub body which is as high as possible with a weight which is as low as possible. In this case, the hollow structure 150 is formed inside the hub body 110 for the turbine wheel 100. The hollow structure 150 has a lattice-like design, wherein in principle all regular or irregular designs can be provided for the hollow structures.

Furthermore, the hollow structure can be formed for example in the form of a plurality of diagonally arranged, parallel planes. Alternatively to this, the hollow structure can also have a honeycomb-like design (not shown).

What is claimed is:

1. A method for generative production of a turbine wheel in one piece via primary forming having a hub body, a plurality of turbine blades integrally formed with the hub body, and a shroud which encompasses the hub body, which is integrally formed with the turbine blades, and which interconnects the respective radial outer edges of the turbine blades, the method comprising:
applying a layer of powdered material having a predetermined layer thickness to a construction platform;
selectively melting the layer of powdered material with reference to a current layer form of the turbine wheel;
moving the construction platform by a predetermined amount; and
repeating applying, selective melting, and moving until a last layer of the turbine wheel is formed.

2. The method according to claim 1, wherein selectively melting the layer of powdered material includes selective laser melting or electron beam melting.

3. The method of claim 1, wherein the predetermined layer thickness is in a range from 50 μm to 500 μm.

4. The method of claim 1, wherein selectively melting at least one layer of powdered material includes fusing molten material with a preceding layer.

5. The method of claim 1, wherein a plurality of turbine wheels are simultaneously produced on the construction platform.

6. The method according to claim 1, wherein moving the construction platform by the predetermined amount includes lowering the construction platform by the predetermined amount.

7. The method according to claim 1, wherein the powdered material includes at least one of (i) a nickel-based alloy, (ii) titanium aluminide, and (iii) a metallic mineral.

8. The method of claim 1, wherein the hub body, in at least one section, has a hollow structure.

9. The method of claim 8, further comprising forming the hollow structure inside of the hub body.

10. The method of claim 9, wherein the hollow structure includes shape substantially similar to a lattice or honeycomb.
